(19) United States
(12) Patent Application Publication
(10) Pub. No.: US 2026/0302758 A1
(43) Pub. Date: Oct. 1, 2026

(54) SYSTEM AND METHOD FOR PROTECTING AGAINST GROUND FAULTS ON POWER RAILS

(71) Applicant: Caterpillar Inc., Peoria, IL (US)

(72) Inventor: Igor Strashny, Tucson, AZ (US)

(73) Assignee: Caterpillar Inc., Peoria, IL (US)

(21) Appl. No.: 19/095,528

(22) Filed: Mar. 31, 2025

(51) Int. Cl. H02H 3/16; H02H 1/00

(52) U.S. Cl. CPC H02H 3/16; H02H 1/0007

(57) ABSTRACT

An electrical power delivery system includes a power module and a rail system with a positive rail, a negative rail, and a ground rail. A resistor network, coupled to the rail system for ground-fault protection, provides a first resistance between the positive rail and the ground rail and a second resistance between the negative rail and the ground rail. An object sensor, coupled to the rail system, is configured to detect a foreign object within a sensing zone adjacent to the rail system. When making a detection, the object sensor affects one of the first resistance and the second resistance, which generates a simulated ground fault and causes the power module to activate an alarm or interrupt the rail system.

### TECHNICAL FIELD

The present disclosure relates generally to a system and method for protecting against ground faults on power rails, and more specifically, to an integrated protection scheme combining object detection and ground fault interruption to guard against electrical shock by personnel or animals.

### BACKGROUND

Rail systems commonly provide power for electric vehicles. For trains, at least one electrified rail is often located outside of two running rails, or in some systems, located between the two running rails. Similar systems supply power to heavy work machines operating at a worksite in a dynamic energy transfer (DET) system, which may include charging while moving (CWM) capability to charge batteries in the machines.

Heavy work machines require significant power to carry out their functions. The machines can be equipment in an industrial environment, such as mining, construction, transportation, energy exploration, farming, or the like. The machines themselves can be of substantial weight, and their loads require large amounts of power to move. They may include work implements, such as augers, brush cutters, brooms, grapples, hammers, pulverizers, rippers, rotors, and shovels, that require extensive power to perform tasks, such as drilling, digging, hauling, raising, and/or depositing material.

Accordingly, power rails may carry substantial voltage, typically 600-1500 VDC, that presents danger to anyone or anything coming into contact with them. To avoid issues from debris or inadvertent contact with rails on the ground, a DET system may elevate its rails along a roadway or haul route. While the elevated rails are often above normal reach, the high voltages between the rails, which may reach 3000 VDC in some situations, still pose safety risks from contact by people or animals.

One approach for protecting against contact of high voltage rails for a moving vehicle is described in U.S. Patent App. Pub. No. 2024/0025303 (“the ’303 publication”). The ’303 publication describes a system of road tracks that power and charge moving vehicles. Radar sensors installed in track modules detect objects, such as other vehicles, people, animals, and weather along the road, and a control server may provide wireless warnings to approaching vehicles. While explaining that the control server may also deactivate track segments to prevent damage to the vehicle and injury to the detected animal or person, the ’303 publication does not address potential electrical shock from contacting the track segments. Nor does the ’303 publication address integrating its detecting system with ground-fault interruption to protect against electrical shock. As a result, the track modules of the ’303 publication do not provide a desirable approach for guarding against ground faults in power rails of a DET system.

Examples of the present disclosure are directed to overcoming deficiencies of such systems.

### SUMMARY

In an aspect of the present disclosure, an electrical power delivery system includes a power supply, a rail system, and a protection circuit. The rail system contains a positive rail coupled to receive positive voltage from the power supply, a negative rail coupled to receive a negative voltage from the power supply, and a ground rail coupled to the power supply and to ground. The protection circuit includes a resistor network coupled to the rail system and configured to provide a first resistance between the positive rail and the ground rail and a second resistance between the negative rail and the ground rail. The protection circuit further includes an object sensor, coupled to the rail system, configured to detect a foreign object within a sensing zone adjacent to the rail system. The object sensor is configured to change one of the first resistance and the second resistance in response to detecting the foreign object within the sensing zone.

In another aspect of the present disclosure, a protection circuit for an electrical power delivery system includes a resistor network and an object sensor. The resistor network is configured to connect a positive conductor and a negative conductor to a ground conductor of the electrical power delivery system. In addition, the resistor network is further configured to provide a first resistance between the positive conductor and the ground conductor and to provide a second resistance between the negative conductor and the ground conductor. The object sensor is configured to detect a foreign object within a zone adjacent to the positive conductor and the negative conductor and is further configured to change one of the first resistance and the second resistance in response to detecting the foreign object within the zone.

In yet another aspect of the present disclosure, a method includes detecting, with an object sensor, a foreign object within a zone adjacent to a positive rail, a negative rail, and a ground rail of an electrical power delivery system. In response to detecting the foreign object within the zone, the method includes altering one of a first resistance between the positive rail and the ground rail and a second resistance between the negative rail and the ground rail. The method further includes identifying, by one or more processors, a difference between a positive voltage across the first resistance and a negative voltage across the second resistance exceeding a first predetermined threshold. In response to identifying the difference exceeding the first predetermined threshold, one or more processors cause an interruption of the electrical power delivery system.

### BRIEF DESCRIPTION OF DRAWINGS

The detailed description references the accompanying figures. In the figures, the left-most digit of a reference number identifies the figure in which the reference number first appears. The same reference numbers indicate similar or identical items.

FIG. 1 is a schematic illustration of an electrical power delivery system in accordance with an example of the present disclosure.

FIG. 2 is an isometric view of a rail support module with power rails in accordance with an example of the present disclosure.

FIG. 3 is a side view of a rail support module with power rails and object detection in accordance with an example of the present disclosure.

FIG. 4 is an end view of a rail support module with power rails and object detection in accordance with an example of the present disclosure.

FIG. 5 is a schematic illustration of a simulated ground-fault circuit within the electrical power delivery system of FIG. 1 in accordance with an example of the present disclosure.

FIG. 6 is a front view of a support assembly including an object sensor in accordance with an example of the present disclosure.

FIG. 7 is a flow chart depicting a method for protecting against ground faults in the electrical power delivery system of FIG. 1 in accordance with an example of the present disclosure.

### DETAILED DESCRIPTION

Consistent with the principles of the present disclosure, in some examples, an electrical power delivery system includes a power module and a rail system with a positive rail, a negative rail, and a ground rail. A resistor network, coupled to the rail system for ground-fault protection, provides a first resistance between the positive rail and the ground rail and a second resistance between the negative rail and the ground rail. An object sensor, coupled to the rail system, is configured to detect a foreign object within a sensing zone adjacent to the rail system. When making a detection, the object sensor affects one of the first resistance and the second resistance, leading to an imbalance that generates a simulated ground fault and causes the power module to activate an alarm or interrupt the rail system. The object detection provides a layered or staged approach to ground-fault detection, integrating a simulated ground fault into ground-fault detection circuitry. Accordingly, the object detection enhances personnel and animal safety with minor changes or additions in equipment or wiring within a rail system. The following describes several examples for carrying out the principles of this disclosure.

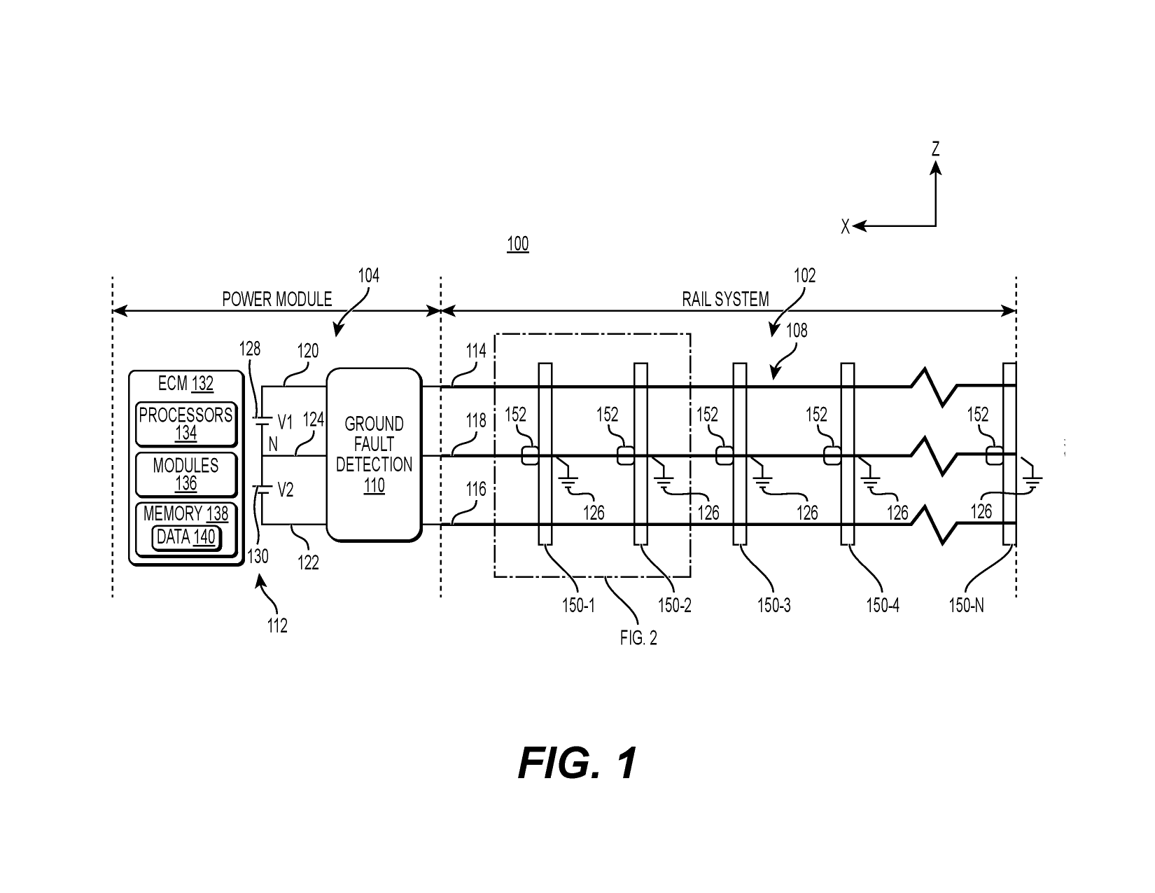

FIG. 1 is a schematic view of an electrical power delivery system 100 as one example operating under normal conditions. Electrical power delivery system 100 may be a dynamic energy transfer (DET) system intended to convey electrical power to a moving vehicle, such as a work machine operating at a worksite. The system may further include charging while moving (CWM) capabilities, providing sufficient current to charge batteries of the moving vehicle. In general, electrical power delivery system 100 includes a rail system 102 receiving electrical power from a power module 104.

In some examples, power rails 108 within rail system 102 include conductors arranged along a path, such as a haul route for a work machine, along a distance. Segments of each conductor may be a rail in the form of a modified I-beam of aluminum, with the segments arranged end-to-end to form a continuous electrical path for the conductor. Further, the conductors are typically arranged side-by-side and separated by a distance to ensure sufficient electrical clearance, such as having a center-to-center distance between adjacent rails of about 200 mm. As depicted in FIG. 1, power rails 108 within rail system 102 include a positive rail 114, a negative rail 116, and a ground rail 118. While generally describing the conductors as three rails, the present disclosure contemplates and includes conductor shapes and forms other than rails and is not limited to the use of three rails.

As shown schematically in FIG. 1, in some situations, positive rail 114 and negative rail 116 are disposed parallel to each other, and the ground rail 118 is disposed parallel to, and between, positive rail 114 and negative rail 116. Ground rail 118 is electrically grounded, or earthed, at a plurality of ground connections 126.

Within electrical power delivery system 100, power module 104 generates and transmits electrical power to power rails 108 of rail system 102. As shown in FIG. 1, power module 104 includes a first power source 128 and a second power source 130 that, operating together, function as a power supply 112 for rail system 102. In some examples, power module 104 receives electrical power from an external source, such as three-phase AC voltage in the range of 11 kV to 33 kV from a medium-voltage distribution line. First power source 128 and second power source 130 respectively convert that AC voltage to positive and negative DC voltage for distribution to power rails 108. For instance, first power source 128 and second power source 130 each may include AC switchgear, step-down transformers, AC/DC voltage converters, DC filters, DC switchgear, and other component sufficient to provide the voltage, current, and power requirements for machinery deriving electrical power from rail system 102.

In the example of FIG. 1, first power source 128 provides an output voltage V1 between positive terminal 120 and neutral terminal 124 of at least +1000 VDC and upwards of approximately +1500 VDC. Conversely, second power source 130 provides an output voltage V2 between negative terminal 122 and neutral terminal 124 of at least -1000 VDC and upwards of approximately -1500 VDC, while neutral terminal 124 is at a neutral or grounded state. Additionally, power module 104 provides upwards of approximately 3000 VDC and 6 MW across positive terminal 120 and negative terminal 122, in some examples.

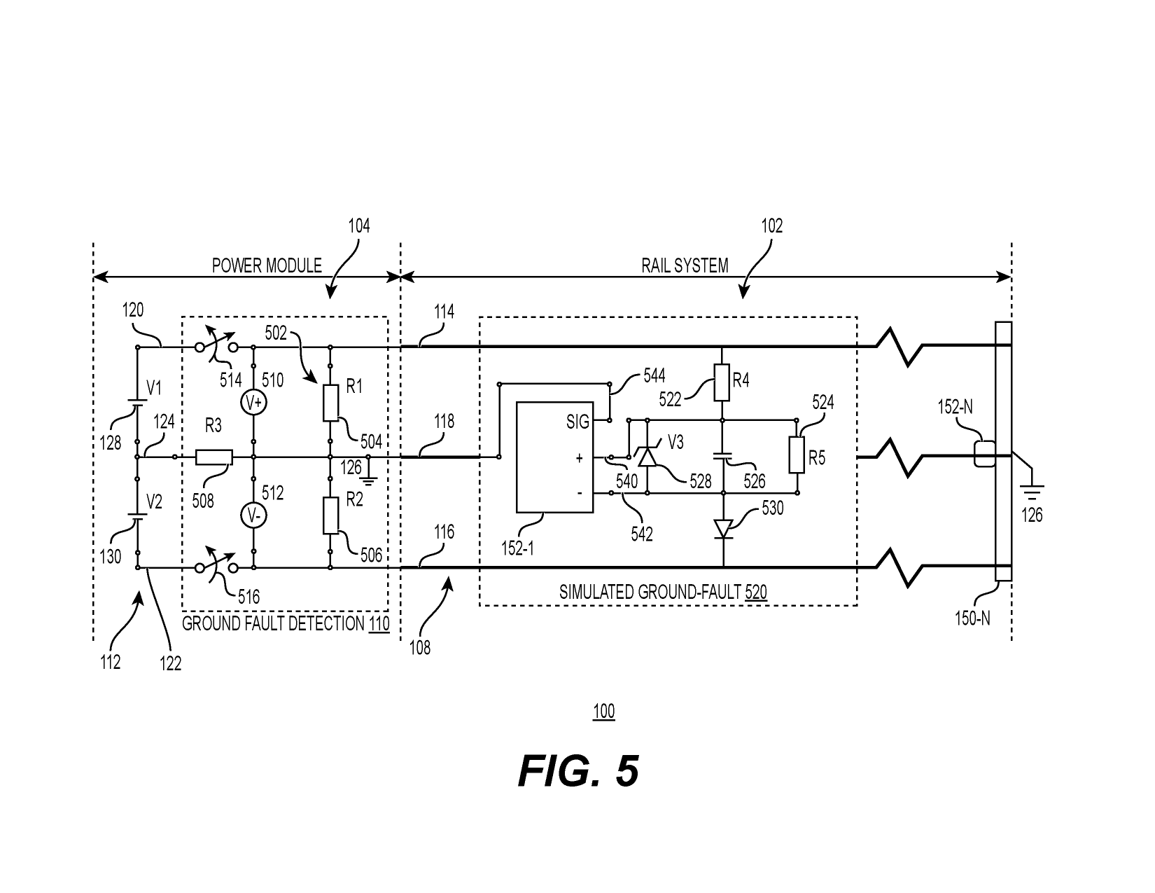

Positive terminal 120, negative terminal 122, and neutral terminal 124 are coupled to positive rail 114, negative rail 116, and ground rail 118, respectively, through a ground-fault detection circuit 110. The ground-fault detection circuit 110 generally includes safety provisions for detecting a low impedance path to ground from one of positive rail 114 and negative rail 116 and interrupting power from power module 104 to rail system 102 to protect against a short circuit or electrical shock. The ground-fault detection circuit 110 is discussed in more detail below with respect to FIG. 5.

In one implementation, power module 104 provides DC electrical energy across positive rail 114 and negative rail 116 for powering an electric engine to cause movement of a work machine via power rails 108, such as 3000 VDC at 6 MW. In another configuration, power module 104 provides DC electrical energy for charging batteries while a work machine (not shown) is stationary, such as by providing voltage V1 or V2 to the work machine via one or more of charge ports, such as 1500 VDC at 3 MW. These values are exemplary, and other physical and electrical configurations for power module 104 and power rails 108 are available and within the knowledge of those of ordinary skill in the art.

The electrical power delivery system 100 may additionally comprise an electronic control module (ECM) 132 to monitor and control various aspects of power module 104 and rail system 102. The ECM 132 houses one or more processors 134, which may execute any modules, components, or systems associated with the electrical power delivery system 100, some of which may be housed in ECM 132 as shown as modules 136. In some examples, processors 134 may include a central processing unit (CPU), a graphics processing unit (GPU), both CPU and GPU, or other processing units or components known in the art. Additionally, each of the processors 134 may possess its own local memory, which also may store program modules, program data, and/or one or more operating systems.

Computer-readable media, such as memory 138, associated with the electrical power delivery system 100 may include volatile memory (e.g., RAM), non-volatile memory (e.g., ROM, flash memory, miniature hard drive, memory card, or the like), or some combination thereof. The computer-readable media may be non-transitory computer-readable media. The computer-readable media may include or be associated with the one or more of the above-noted modules, which perform various operations associated with the electrical power delivery system 100. In some examples, one or more of the modules may include or be associated with computer-executable instructions that are stored by the computer-readable media and that are executable by one or more processors to perform such operations. The memory 138 may store various data 140 associated with the operation of the electrical power delivery system 100.

Referring from power module 104 back to rail system 102, power rails 108 are secured by a collection of support assemblies 150, which elevate the rails above the ground. In some examples, such as in a mining site, power rails 108 can extend along a haul route for kilometers. As a result, a large number of support assemblies 150 may be included in rail system 102, which in FIG. 1 are distinguished with a numerical suffix to indicate first support assembly 150-1, second support assembly 150-2, third support assembly 150-3, fourth support assembly 150-4, and an nth support assembly 150-N. The rail system 102 is not limited to a particular number of support assemblies within rail system 102; less than the five depicted in FIG. 1 may be included as well as a number greater than five depending on the distance of power rails 108.

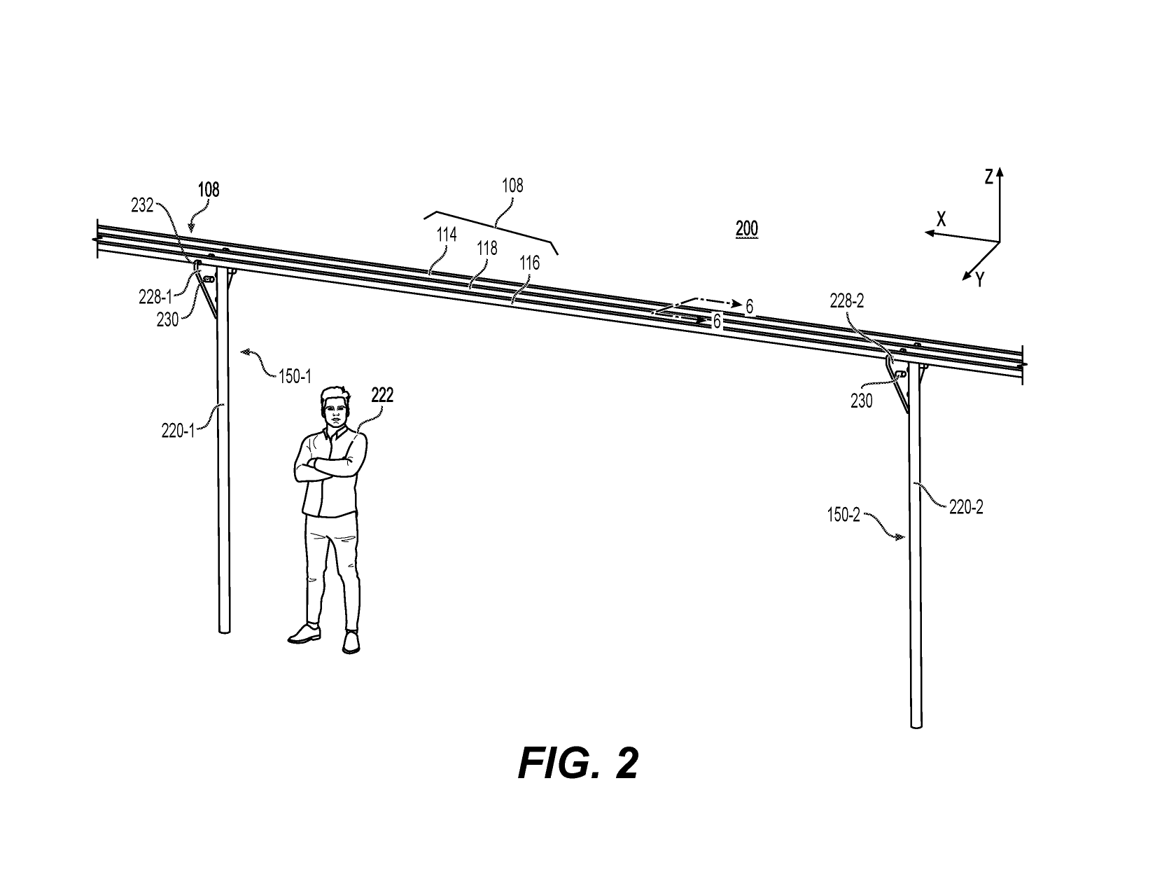

FIG. 2 is an isometric view of a portion of rail system 102, namely, a rail support module 200 within rail system 102 that includes a first support assembly 150-1 and a second support assembly 150-2. As shown in FIG. 2, the rail support assemblies hold power rails 108 from below and are arranged longitudinally along a path. Each of the support assemblies 150 includes a variety of components such as support poles 220 and support plates 228 for securing power rails 108 at an elevated position above ground.

First support pole 220-1 and second support pole 220-2 shown in FIG. 2 are rods, poles, posts, cylinders, stanchions, or similar structures made of dielectric material and having a length for elevating and supporting power rails 108 above ground. In some examples, first support pole 220-1 and second support pole 220-2 are pipes made of a pultruded FRP, or similar dielectric or electrically insulative materials. One end of each of support poles 220 may be seated within a hole in the ground, such as a ground screw, while the other end of each pole supports power rails 108. Alternatively, one end of each pole may be fixed within a weighted footing (e.g., concrete barrier), while the other end of each pole supports power rails 108.

The support poles 220 have lengths sufficient to stabilize power rails 108 at a safe height above the ground. A safe height may be a height that most humans (e.g., 99% of humans based on average reach) are unable to reach without assistance. For example, the rail may be elevated at least three meters above the ground. This height prevents workers within the operational environment from accidentally touching the rail, thereby reducing the likelihood of electrocution and improving safety for the delivery of electrical power for a moving machine. Although power rails 108 may be electrically isolated in a manner to avoid risks of shock or electrocution, the height of power rails 108 also precludes individuals such as person 222 from easily touching power rails 108 while grounded. In addition, the elevated position minimizes the risk of contamination by ground debris or contact from animals or unauthorized individuals on the ground.

Shown in the example of FIG. 2, support plates 228 are flat structures that may similarly be made of pultruded FRP or other dielectric materials and are configured to support two or more of power rails 108. Support plates 228 may be attached to support poles 202 by way of one or more fasteners 230 and associated components. The power rails 108 are positioned to rest within slots along a top edge of each of the support plates 228. In this configuration, a top surface of each rail is exposed vertically above top edge 232, which enables unobstructed engagement on the top surface of each rail by a sliding contactor or current collector of a moving work machine.

As shown in FIG. 1, rail system 102 includes one or more object sensors 152 that may be installed on the respective support assemblies 150. The object sensors 152 may be any electronic device configured to sense the presence of a physical object within a zone of detection proximate to the device. As known to those of ordinary skill in the field, various technologies can accomplish non-contact sensing of physical objects, particularly humans or animals, such as proximity sensors, presence sensors, and motion sensors. For instance, these devices may use sound waves (ultrasonic sensors), active infrared beams (photoelectric sensors), passive infrared reception (passive IR sensors), laser pulses (LiDAR), electromagnetic fields (inductive sensors), capacitance (capacitive sensors), microwaves (motion sensors), etc. By the term “object sensors,” this disclosure refers to electromechanical devices incorporating any of the technologies capable of sensing the presence of a human or animal within a zone of detection proximate to the device.

In one implementation, one or more of object sensors 152 are ultrasonic proximity sensors. Ultrasonic sensors emit and receive sound waves to detect objects within a region. Certain ultrasonic sensors further include the ability to determine a distance of the object from the sensor. An ultrasonic sensor suitable as one or more of the object sensors 152 of the present disclosure is the USS6.5 ultrasonic sensor available from Bosch Mobility of Robert Bosch GmbH. The USS6.5 ultrasonic sensors function according to echo sounding principles, emitting ultrasonic waves that are reflected by objects within their field of view and re-emitted by the sensor. The signal echoes received by the sensors are evaluated in a central control unit and distances are determined with centimeter precision and at high speed. The proximity sensor can detect physical objects and their distances at ranges of about 15 cm to 550 cm.

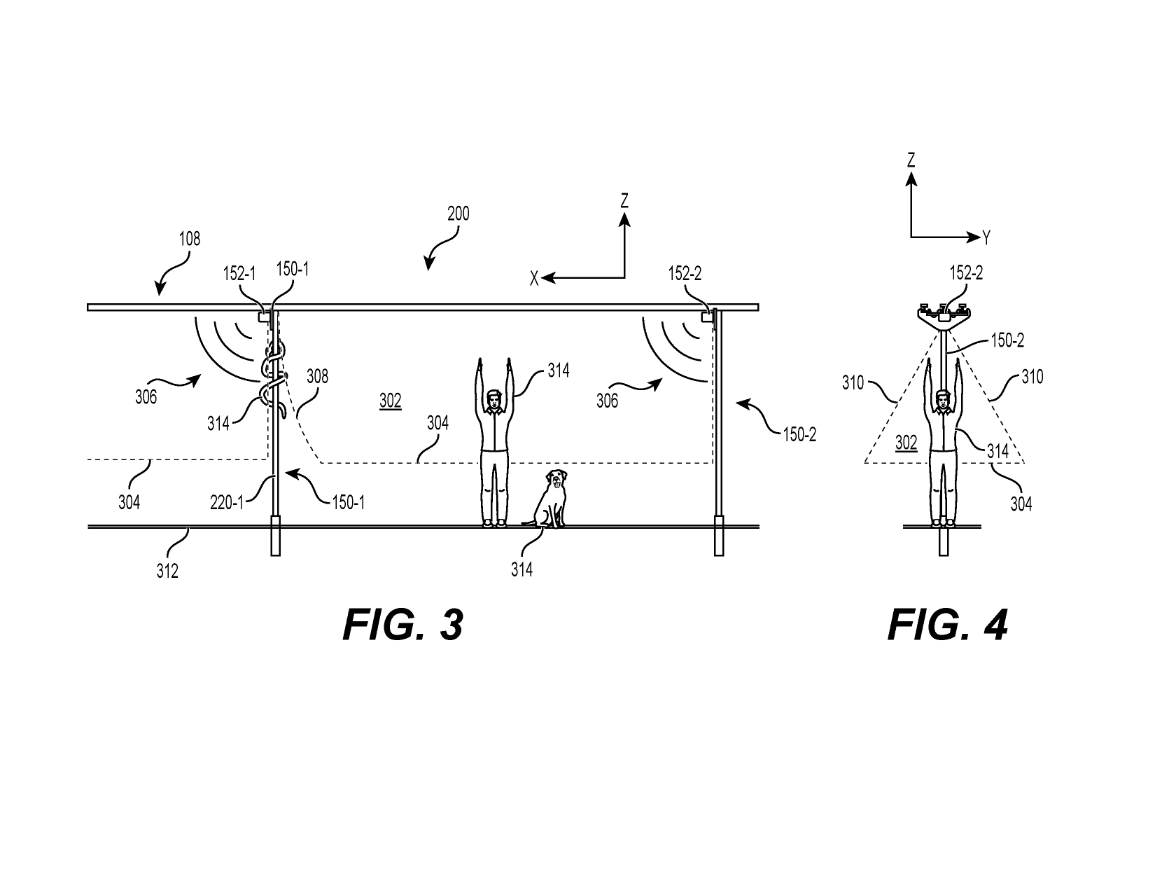

In accordance with the principles of the present disclosure, the object sensors 152, such as proximity sensors, are configured within rail system 102 to enable detection of a person or animal that is in proximity to power rails 108 and, therefore, potentially at risk of touching positive rail 114 or negative rail 116 and receiving an electrical shock. FIG. 1 illustrates object sensors 152 positioned on each of support assemblies 150 in one option. In other options, one or more of the object sensors 152 may alternatively be placed elsewhere within rail system 102 sufficient to sense the presence of a person or animal in a region proximate or adjacent to power rails 108. FIGS. 3 and 4 illustrate a possible zone of detection for object sensors 152 when installed on support assemblies 150.

FIG. 3 is a side view of a schematic illustration of rail support module 200, while FIG. 4 is an end view of the schematic illustration of rail support module 200 in FIG. 3 facing toward second support assembly 150-2. In this example, the object sensors 152 are mounted on each of the support assemblies 150, i.e., first object sensor 152-1 is mounted on first support assembly 150-1 and second object sensor 152-2 is mounted on second support assembly 150-2, both just below power rails 108. While FIGS. 3 and 4 show object sensors 152 on the left side of support assemblies 150, i.e., facing in the X direction toward power module 104, object sensors 152 may be located in any position advantageous for accomplishing the goals set forth in this disclosure, including being on the right side of support assemblies 150 facing away from power module 104 (i.e., facing in the -X direction).

Referring to FIG. 3, second object sensor 152-2 as an example is configured to emit and receive electromagnetic waves 306 to sense a physical object within a zone 302 adjacent or proximate to power rails 108 between first support assembly 150-1 and second support assembly 150-2. The zone 302 may span any region near power rails 108 suitable for purposes of protection for electrical power delivery system 100. In the example of FIGS. 3 and 4, zone 302 covers an area beneath power rails 108 towards the ground (in the X-Z plane) and on lateral sides of the rails (in the Y direction). In other examples, zone 302 may include an area above the rails as well to guard against potential contact of the rails from that direction. These are examples, and the positioning and arrangement object sensors 152 to set detection zones such as zone 302 will vary based on the implementation of electrical power delivery system 100 and are within the knowledge of those of ordinary skill in the field.

In some examples, the object sensors 152 can be configured to have a geometric field of view. When a Bosch USS6.5 proximity sensor is used, the zone 302 where objects are sensed can span about 70 degrees along a horizontal axis (i.e., along the X axis in FIG. 3) and about 35 degrees along a vertical axis (i.e., along the Y axis in FIG. 4). In the example of FIGS. 3 and 4, zone 302 has a lower boundary 304, an end boundary 308, and a side boundary 310 based on these detection angles. Further, the distance at which objects are detected can be filtered according to their distance. Thus, as shown in FIG. 3, second object sensor 152-2 may be configured in some examples so that zone 302 has a lower boundary 304 that is, for instance, one meter above ground 312. Only when objects are located above lower boundary 304 and within zone 302 does second object sensor 152-2 register a detection. Therefore, second object sensor 152-2 will not register the presence of a small animal unable to reach power rails 108 or vegetation along ground 312.

FIG. 3 includes three examples of a foreign object 314, i.e., an object not intended to be within zone 302. A first foreign object 314 under power rails 108 is a person, whose height extends above lower boundary 304 and into zone 302. FIG. 4 similarly shows the presence of the person as a foreign object 314 within zone 302 as the person stands within side boundary 310 to the person’s left and right along the Y axis. As a result, second object sensor 152-2 will detect the person as a foreign object 314. A second possible foreign object 314 adjacent to power rails 108 is a dog, whose height does not extend above lower boundary 304. Because the dog is not within zone 302, second object sensor 152-2 will not register a detection of the dog as a foreign object 314. A third possible foreign object 314 is a snake climbing on first support pole 220-1. Due to end boundary 308, the snake may be outside zone 302 of second object sensor 152-2 during at least part of its climb on the support pole and will not be detected by second object sensor 152-2. On the other hand, first object sensor 152-1 may detect the snake as a foreign object 314 as it passes within zone 302 of first object sensor 152-1.

As indicated in these figures, a configurable proximity sensor as one or more of object sensors 152 may enable a zone 302 of detection by electromagnetic waves 306 that resembles a cone. Further, the shape of the cone can be modified based on distances from the detection device, such as by having lower boundary 304 higher than a level that may sense objects not likely to be a concern for contacting power rails 108. It will be appreciated that other placements of the sensor and settings for its sensing zone 302 may be adopted based on the implementation, environment, and protection sought. Also, while discussed in terms of an ultrasonic proximity sensor emitting sound waves, the sensing by object sensors 152 may occur by emitting infrared light waves, microwaves, or the like or by passively receiving infrared signals, electromagnetic fields, or the like to detect the presence of a person or animal in the detection zone that may be at risk of contacting power rails 108.

While FIGS. 2-4 illustrate configurations for detecting a foreign object 314 in a region adjacent or proximate to power rails 108 using one or more of object sensors 152, FIG. 5 is a partial schematic diagram of electrical power delivery system 100 providing more detail of the operation of one of the object sensors 152 integrated with the ground-fault detection circuit 110 in power module 104. At the left of FIG. 5, ground-fault detection circuit 110 is coupled between positive terminal 120, negative terminal 122, and neutral terminal 124 and positive rail 114, negative rail 116, and ground rail 118, respectively. The ground-fault detection circuit 110 functions to detect a short circuit to ground, or at least a path to ground through a low impedance, from either positive rail 114 or negative rail 116.

In normal operation, ground-fault detection circuit 110 maintains a balanced resistance between the positive and negative sides of rail system 102, that is, between positive rail 114 and ground rail 118 and between negative rail 116 and ground rail 118. That balance is represented by a resistor network 502 containing first resistor 504 and second resistor 506. The resistor network 502 is shown in FIG. 5 as being within power module 104, but additional resistors typically will be included at the termination end of rail system 102 near nth support assembly 150-N, i.e., farthest along power rails 108 from power module 104. These termination resistors would be placed between positive rail 114 and ground rail 118 and between negative rail 116 to ground rail 118. Wherever they are implemented along electrical power delivery system 100, the resistors between the energized rails and the ground rail accumulate respectively to a first resistance value R1 and a second resistance value R2 within rail system 102 that are substantially equal, or balanced, in value during normal operation of electrical power delivery system 100. Some variations in resistance values R1 and R2 are possible while still achieving comparable outcomes for detecting ground faults as discussed in this disclosure. A third resistor 508, having a third resistance value R3, is coupled to neutral terminal 124 at one end, and is grounded via the ground connection 126 and also connected to ground rail 118 at its other end.

The ground-fault detection circuit 110 further includes at least a first voltage monitor 510, a second voltage monitor 512, a first switch 514, and a second switch 516. The first voltage monitor 510 is coupled to positive rail 114 and to one end of third resistor 508, and therefore to ground rail 118, for monitoring a first voltage, V+, between positive rail 114 and ground rail 118. The second voltage monitor 512 is coupled to negative rail 116 and one end of third resistor 508, and therefore to ground rail 118, for monitoring a second voltage, V-, between negative rail 116 and ground rail 118. Under normal operating conditions, the first voltage V+, monitored or read by first voltage monitor 510, is substantially the same as the voltage at positive terminal 120 (V1). In one example, the value of V1 may be +1500 VDC. Likewise, the second voltage V-, monitored or read by second voltage monitor 512, is the same as the voltage at negative terminal 122 (V2). In this example, the value of V2 may be -1500 VDC. In other words, the magnitude of the first voltage V+ is the same as the second voltage V- under normal operating conditions.

In an abnormal operating condition, the first voltage V+ will be different from the second voltage V-. The difference in the voltage magnitude between the first voltage and the second voltage may be greater than a preselected value, 100 VDC for example, to be considered as an abnormal voltage difference. In the context of the present disclosure, an abnormal operating condition leading to an abnormal voltage difference exists in some examples when a ground path arises from either positive rail 114 or negative rail 116. These abnormal operating conditions from a ground path may include at least positive rail 114 or negative rail 116 grounded through a first object and positive rail 114 or negative rail 116 electrically connected to ground rail 118 though a second object.

In more detail, a ground path formed by positive rail 114 or negative rail 116 electrically connected to ground rail 118 may occur through the contact of first object to either of the energized rails while being in touch with the ground. For instance, a machine, which is grounded via its wheels, could be a first object. The ground path through the truck and its tires will result in a fault impedance of approximately 50 kΩ from either electrified rail to the ground. In an example of V+ being +1500 VDC and V- being -1500 VDC in a normal condition and with R1 and R2 each being 250 kΩ, the first voltage V1 will change to approximately 2100 VDC, and the second voltage V2 will change to approximately -900 VDC, as approximately 18 mA passes through the 50 kΩ fault impedance of the truck to ground. The difference in absolute voltage measured by first voltage monitor 510 and second voltage monitor 512 would be 1200 VDC, which is in excess of 100 VDC and sufficient to be considered as an abnormal voltage difference by ECM 132.

As another example, an animal or person, which is grounded via its feet, could be a first object or a third object as mentioned above that contacts one of positive rail 114 or negative rail 116. The ground path through the animal or person would have a fault impedance less than a truck, such as approximately 5 kΩ for a large animal such as an elephant, or on the order of 1 kΩ for a person. In an example of V+ being +1500 VDC and V- being -1500 VDC in a normal condition and with R1 and R2 each being 250 kΩ, the first voltage V1 will change to approximately 2800 VDC, and the second voltage V2 will change to approximately -200 VDC, as approximately 38 mA passes through a 5 kΩ fault impedance of the animal to ground. The difference in absolute voltage measured by first voltage monitor 510 and second voltage monitor 512 would be 2800 VDC, in excess of the 100 VDC threshold and sufficient to be considered as an abnormal voltage difference by ECM 132.

In a further example, a ground path may be formed by positive rail 114 or negative rail 116 being electrically connected to ground rail 118 though a second object simultaneously contacting both energized rails. For instance, a small animal climbing in power rails 108, such as a snake, may contact either energized rail and the ground rail at once. The ground path through the snake will result in a fault impedance of approximately 500 Ω from either electrified rail to the ground rail. In an example of V+ being +1500 VDC and V- being -1500 VDC in a normal condition and with R1 and R2 each being 250 kΩ, the first voltage V1 will change to approximately 2950 VDC, and the second voltage V2 will change to approximately -50 VDC, as approximately 44 mA passes through a 500 Ω fault impedance across the snake. The difference in absolute voltage measured by first voltage monitor 510 and second voltage monitor 512 in this situation would be 2900 VDC, in excess of the 100 VDC threshold and sufficient to be considered as an abnormal voltage difference by ECM 132.

When an abnormal voltage difference arises, such as a difference in absolute voltage measured by the detectors exceeding 100 VDC, ECM 132 may cause electrical power delivery system 100 to take one or more protective actions. For example, ECM 132 may cause one or both of first switch 514 and second switch 516 to trip open to disconnect power supply 112 from rail system 102. In other examples, electrical power delivery system 100, perhaps under the control of ECM 132, may be configured to generate an alarm. The alarm may be displayed on a display of the power supply, transmitted to a back office associated with electrical power delivery system 100, and/or sounded to notify an operator of electrical power delivery system 100, among other options. Further, as discussed in more detail below, ECM 132 may be configured to have discretion in the speed at which protective measures are taken. For instance, as indicated in the examples above, a higher abnormal voltage difference indicates a higher fault current and risk of harm and, therefore, perhaps a need to trip open first switch 514 and/or second switch 516 more quickly. Conversely, an abnormal voltage difference only slightly above 100 V suggests a lower fault current and lower risk of harm, perhaps providing more time to allow the fault to end naturally before disconnecting power supply 112 from rail system 102.

At the right-hand side of FIG. 5, a representative simulated ground-fault circuit 520 within rail system 102 is coupled to each of positive rail 114, negative rail 116, and ground rail 118. While one simulated ground-fault circuit 520 is depicted in FIG. 5, multiple circuits of this type may be implemented along rail system 102, such as within each of the support assemblies 150. FIG. 5 shows simulated ground-fault circuit 520 as a first instance of object detection along rail system 102 downstream from power module 104. Accordingly, simulated ground-fault circuit 520 in FIG. 5 includes first object sensor 152-1, which in the illustrated example contains a first power input 540, a second power input 542, and a sensor output 544.

The simulated ground-fault circuit 520 includes circuitry for generating supply voltage for first object sensor 152-1 from power rails 108. In one example, a fourth resistor 522 is coupled at one end to positive rail 114 and at an opposite end to first power input 540. A parallel arrangement of at least a fifth resistor 524, a capacitor 526, and a zener diode 528 are connected across first power input 540 and second power input 542. The second power input 542 is coupled to negative rail 116, possibly through a light source 530, such as a light emitting diode. The sensor output 544 is coupled to ground rail 118. In one example, first object sensor 152-1 is a Bosch USS6.5 proximity sensor, fourth resistor 522 is 50 kΩ, fifth resistor 524 is 400 Ω, and capacitor 526 is 100 μF. With V1 equal to +1500 VDC and V2 equal to -1500 VDC, capacitor 526 will provide about 16 VDC as supply voltage for first object sensor 152-1 across first power input 540 and second power input 542. When illuminated, light source 530 can provide a visual indicator to personnel near simulated ground-fault circuit 520 that rail system 102 is energized. These components and values are exemplary and other options for providing supply voltage to first object sensor 152-1 are available to those of ordinary skill in the field without departing from the principles of the present disclosure.

In some examples, first object sensor 152-1 is configured to change an impedance at its sensor output 544 based on whether the device detects the presence of an object within its zone 302. For instance, first object sensor 152-1 may provide an open circuit, or essentially infinite impedance, at sensor output 544 in a first state during normal operation when it does not detect an object. In this situation, first object sensor 152-1 does not have an impact on resistor network 502 or on the measurements taken by first voltage monitor 510 and second voltage monitor 512. When first object sensor 152-1 detects an object within its zone 302, such as foreign object 314, the first object sensor 152-1 in some examples will switch to a second state that changes the impedance on sensor output 544 to be different from an open circuit. That impedance may still be of substantial value, such as several hundred kΩ, but its placement in parallel with one of first resistor 504 or second resistor 506 will form a resistor divider that will lead to an imbalance within resistor network 502.

For example, when first object sensor 152-1 is a Bosch USS6.5 proximity sensor, the sensor may switch its state at sensor output 544 upon detecting a foreign object 314 from an open circuit or equivalent arrangement with an impedance of tens of megaohms, for example, to one having a lesser impedance of hundreds of kiloohms, for example. In this implementation, the new impedance of hundreds of kiloohms would be internal to first object sensor 152-1 or may be affected based on the programming of a controller within first object sensor 152-1, if available. In other options, resistors external to first object sensor 152-1 could be provided to set a desired new impedance for the sensor on sensor output 544 upon detection a foreign object 314. The new impedance of several hundred kiloohms on sensor output 544, which may be applied to either the positive or negative side of rail system 102, will be applied in parallel to either first resistance value R1 or second resistance value R2.

The change in impedance within sensor output 544 following the detection of a foreign object 314 will affect the balance of resistance within resistor network 502. That change in balance will, in turn, cause a difference in voltage values measured by first voltage monitor 510 and second voltage monitor 512. Accordingly, ECM 132, by one or more of modules 136, may compare the voltage values from first voltage monitor 510 and second voltage monitor 512 and determine whether electrical power delivery system 100 is operating normally as described above. In response to determining that the difference in absolute value of the voltage values exceeds a predetermined threshold for an abnormal voltage difference, such as 100 VDC, ECM 132 may cause one or both of first switch 514 and second switch 516 to trip open to disconnect power supply 112 from rail system 102.

Alternatively, ECM 132 may determine that the abnormal voltage difference is within a range indicative of one of the object sensors 152 detecting a foreign object 314 and, therefore, conclude that the difference is an artificial ground fault. For example, when identifying a foreign object 314, the first object sensor 152-1 may be configured to cause an abnormal voltage difference between first voltage monitor 510 and second voltage monitor 512 that is between 100 VDC and 1200 VDC, with 1200 VDC being the voltage difference caused by the grounding of a truck against one of the energized rails as discussed above. In the context of the examples discussed above, to cause a voltage difference in this range, first object sensor 152-1 would introduce an impedance in excess of about 50 kΩ across either energized rail and ground rail 118. When the voltage difference is within this range, ECM 132 may take remedial action appropriate to an artificial or simulated ground fault, such as tripping open one or both of first switch 514 and second switch 516, generating an alarm, displaying a warning, transmitting a message to a back office associated with electrical power delivery system 100, and/or notifying an operator of electrical power delivery system 100.

As well, after determining the abnormal voltage difference as a simulated ground fault, ECM 132 may wait before taking any action to allow conditions to change. That is, the presence of foreign object 314 may be transient, and the person or animal may soon move out of zone 302 and away from danger of contacting power rails 108, avoiding the need to activate an alarm or to disconnect rail system 102.

In this way, object sensors 152 according to this disclosure may essentially generate a simulated ground fault for electrical power delivery system 100. When a person or animal comes in proximity to power rails 108, one of the object sensors 152 will cause an abnormal voltage difference upon which ECM 132 can act, possibly before the person or animal contacts the power rails 108. Thus, an alarm may provide a sufficient warning to deter any contact. With this simulated ground fault, the present system provides a layered approach to protecting against harm from ground faults within electrical power delivery system 100.

In accordance with the principles of the present disclosure, simulated ground-fault circuit 520 associated with different ones of support assemblies 150 may be configured or implemented differently to cause a distinctive abnormal voltage difference within ground-fault detection circuit 110. For example, a simulated ground-fault circuit 520 within first support assembly 150-1 may be configured to cause an abnormal voltage difference at ground-fault detection circuit 110 of approximately 150 VDC, while the simulated ground-fault circuit 520 within second support assembly 150-2—specifically, object sensor 152-2 when a programmable Bosch USS6.5 proximity sensor or similar device—may be configured to cause an abnormal voltage difference of approximately 200 VDC. ECM 132 may, therefore, be able to differentiate the location of foreign object 314 along rail system 102 based on the abnormal voltage difference.

In other examples, upon detecting a foreign object 314, first object sensor 152-1 may be configured to cause the impedance at sensor output 544 to change over time. For instance, first object sensor 152-1 may have a characteristic frequency at which it changes from a first open state to a second closed state, thereby causing an abnormal voltage difference to arise at ground-fault detection circuit 110 that changes over time as well. This change in time may be at a predetermined frequency programmed within first object sensor 152-1. In this example, ECM 132, through modules 136, will evaluate the abnormal voltage difference over time to identify both the existence of a foreign object 314 and the frequency of the abnormal voltage difference, from which ECM 132 may determine the particular zone 302 at which the foreign object 314 has been detected. Other ones of the object sensors 152 may be different characteristic patterns, or frequencies, for switching between a first state and second state. As a result, ECM 132 will be able to differentiate between detections among object sensors 152.

Similarly, the object sensors may operate as a type of single-wire serial interface to power module 104. In detecting a foreign object within zone 302, one or more of the object sensors 152 may cause a change in impedance over time on sensor output 544 that also provides a data stream on ground rail 118 that is readable by ECM 132. The data stream could include information indicative of the location of foreign object 314 along power rails 108, a distance of the object from the sensor, a location of the object within zone 302, movement of the object, and other information usable by ECM 132.

While these capabilities of simulated ground-fault circuit 520 may increase with the sophistication of the devices chosen for object sensors 152, the basic features of detecting a foreign object within zone 302 and affecting a first resistance value R1 or a second resistance value R2 within power module 104 will apply to less sophisticated devices as well. For instance, it will be appreciated that object sensors 152 may be implemented with motion detectors commonly used in security systems with infrared technology and associated switching circuitry. These and other common options for object sensors 152 may not include advanced capability for signaling to ECM 132, but they can readily generate an artificial ground fault consistent with this disclosure within simulated ground-fault circuit 520 to guard against electrical shock by a person or animal.

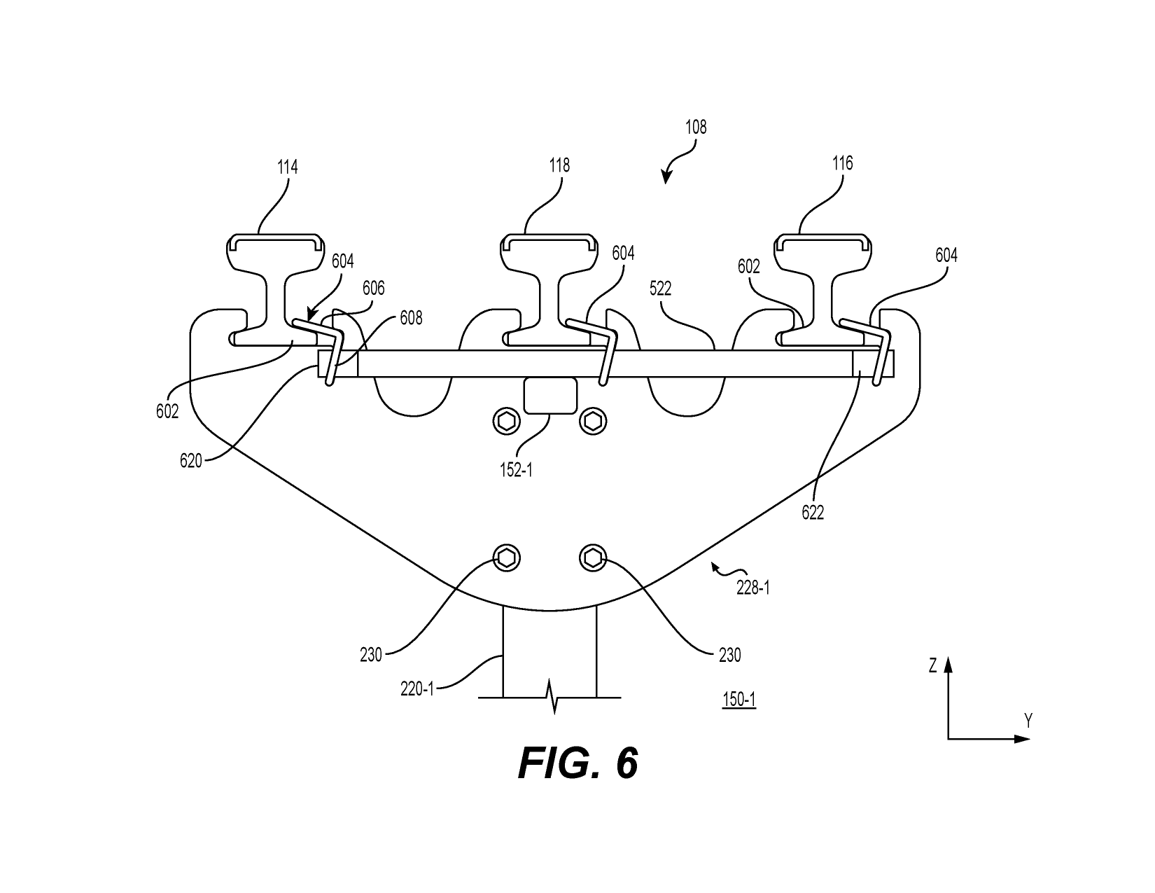

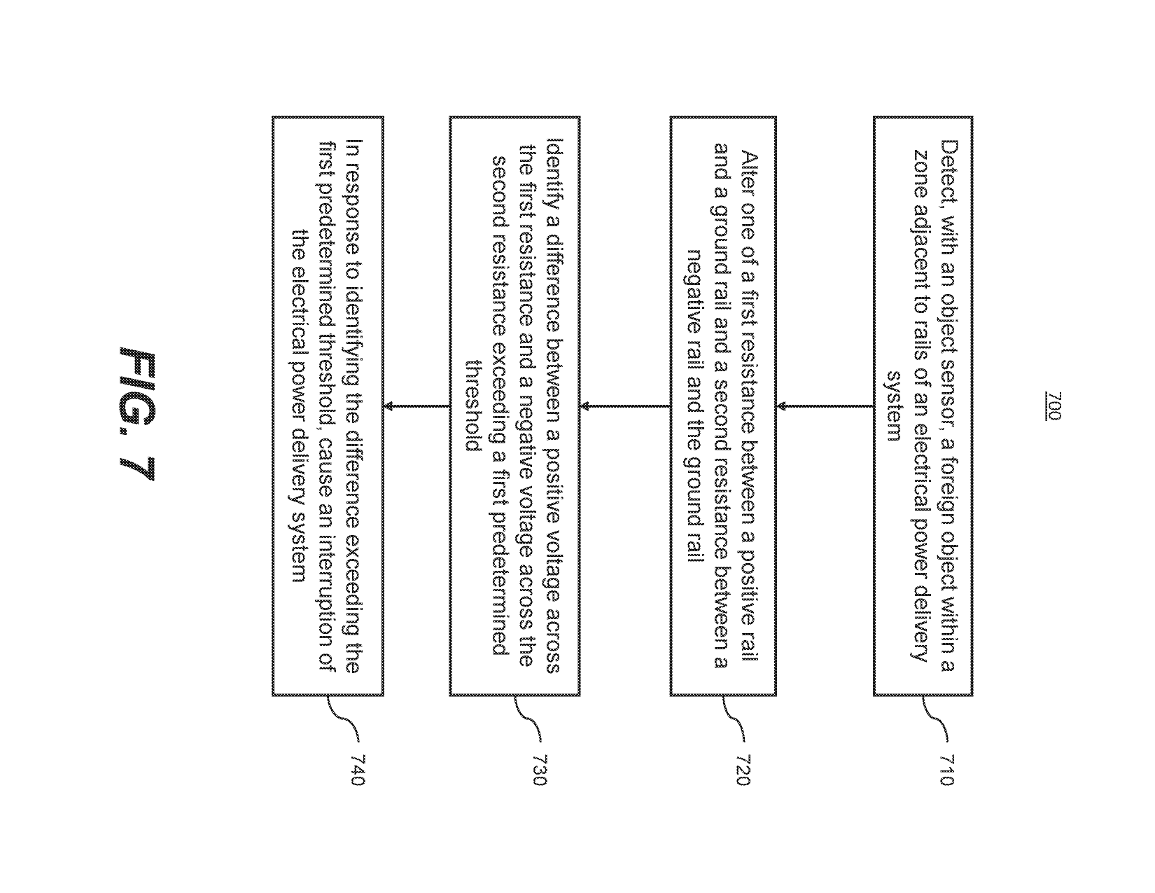

While FIG. 5 addresses the circuitry for accomplished a simulated ground fault in electrical power delivery system 100, FIG. 6 illustrates an option for mounting object sensors 152 on support assemblies 150 in accordance with the principles of the present disclosure. FIG. 6 is a front view of one implementation for first support assembly 150-1 from a perspective looking away from power module 104 and down rail system 102 along the -X axis in the figures. The first support assembly 150-1 includes a first support pole 220-1 and a first support plate 228-1 for holding power rails 108 in an elevated position to provide electrical power. The first support plate 228-1 is a flat structure that may be made of pultruded FRP or other dielectric materials and is configured to support two or more of power rails 108 elevated above ground by first support pole 220-1. First support plate 228-1 may be attached to first support pole 220-1 by way of one or more fasteners 230.

In the example illustrated, first support plate 228-1 typically has a flat or planar surface with the lower portion of first support plate 228-1 generally having a curved or angled profile. A top edge of first support plate 228-1 includes several slots or indentations for accommodating power rails 108, shown as positive rail 114 at the left, negative rail 116 at the right, and ground rail 118 in the middle. In this configuration, the top surface of each of power rails 108 is exposed vertically, which enables unobstructed engagement by a contactor or current collector of a work machine that may slide along the top surface. As shown in the example of FIG. 6, each of power rails 108 has a flanged bottom 602 against which clips 604 frictionally lock power rails 108 to first support plate 228-1. In some examples, clips 604 have an upper section 606 and a lower section 608. The two sections of clips 604 may be angular, curved, or linear with respect to each other. In the examples illustrated, the two sections of the clips form an angle, typically acute or approximating 90 degrees, where a shape of the clips resembles an angle bracket. The angle creates a resilient springing action between upper section 606 and lower section 608 if those sections are stretched or pulled away from each other.

FIG. 6 further illustrates first object sensor 152-1 and fourth resistor 522 positioned on the front face of first support plate 228-1. As discussed for FIG. 5, fourth resistor 522 provides a voltage drop between positive rail 114 and negative rail 116 and, in conjunction with other components of simulated ground-fault circuit 520 not shown, provide a supply voltage to first object sensor 152-1. The clips 604 provide a conductive path from a first end 620 of the resistor to positive rail 114 and from a second end 622 of the resistor to negative rail 116, which may include electrical paths through the other components of simulated ground-fault circuit 520. As a cylindrical or rod-shaped ceramic resistor, fourth resistor 522 may provide additional functions for electrical power delivery system 100, such as generating a desired quantity of heat energy when the power rails are energized. In some examples, generation of 80-120 Watts of heat energy when positive rail 114 conducts about +1500 VDC and negative rail 116 conducts about -1500 VDC should help melt accumulated snow and evaporate moisture on first support plate 228-1. Accordingly, moisture collecting on top edge 210 will be evaporated, which will help avoid deleterious effects from current leakage through first support plate 228-1 or dielectric breakdown of first support plate 228-1. In addition to generating heat, resistor 340 also may serve as a ballast load for power module 104.

The first object sensor 152-1 may be mounted to first support plate 228-1 in any manner or location appropriate for the implementation. As depicted, first object sensor 152-1 is attached below fourth resistor 522, which enables convenient electrical coupling with fourth resistor 522 and an unobstructed path for sensing objects within a zone 302. It will be understood to those of ordinary skill in the art that first object sensor 152-1 may be associated with first support plate 228-1 differently than shown in FIG. 6, such as being attached to first support pole 220-1, and may be affixed to a separate structure to provide zone 302 in an area proximate or adjacent to power rails 108.

Turning from the structure and operation of electrical power delivery system 100 as illustrated in FIGS. 1-6 to a method involving this system, FIG. 7 is a flowchart of a representative method for protecting against ground faults on power rails. The example method 700 is illustrated as a collection of steps in a logical flow diagram, which represents operations that can be performed in the operation of an electrical power delivery system. The order in which the operations are described is not intended to be construed as a limitation, and any number of the described steps can be combined and performed in any order, in parallel, or simultaneously to implement the process.

Generally embodied as 700 in FIG. 7, the method begins with step 710 of detecting, with an object sensor, a foreign object within a zone adjacent to a positive rail, a negative rail, and a ground rail of an electrical power delivery system. As explained above with respect to FIGS. 1-6, an electrical power delivery system 100 may include a rail system 102 that has power rails 108 including a positive rail 114, a negative rail 116, and ground rail 118. One or more object sensors 152 may be positioned along power rails 108 to detect the presence of a foreign object 314 within a zone 302 monitored by the sensor. The object sensor is positioned such that zone 302 is adjacent or proximate to any of power rails 108, i.e., within range of being touched. The object sensors 152 may use any technology to sense the presence of a foreign object 314, such as by using sound waves (ultrasonic sensors), active infrared beams (photoelectric sensors), passive infrared reception (passive IR sensors), laser pulses (LiDAR), electromagnetic fields (inductive sensors), capacitance (capacitive sensors), microwaves (motion sensors), etc. In response to the detection, the object sensors 152 operate an electrical switch or otherwise generate an electrical action in response to the detection.

In a second step 720, in response to detecting the foreign object within the zone, either of two resistances is altered: a first resistance between the positive rail and the ground rail or a second resistance between the negative rail and the ground rail. FIG. 5 illustrates a resistor network 502 within a power module 104 of electrical power delivery system 100 that contains a first resistor 504 and a second resistor 506. In normal operation, a first resistance value R1 of first resistor 504 is substantially equal to a second resistance value R2 of second resistor 506. Upon detecting foreign object 314 within a zone 302, one of the object sensors 152 will generate an electrical action, such as closing an internal switch, to change a resistance or impedance between positive rail 114 and ground rail 118 or between negative rail 116 and ground rail 118. In some examples, object sensors 152 will normally operate by presenting an open circuit, or essentially infinite impedance, on ground rail 118. With the detection of foreign object 314, the affected one of the object sensors 152 will switch from an open circuit to a closed circuit and introduce a changed resistance on ground rail 118, thereby changing the balance of resistance between R1 and R2 in resistor network 502.

In a step 730 for FIG. 7, one or more processors identify a difference between a positive voltage across the first resistance and a negative voltage across the second resistance exceeding a first predetermined threshold. In one example, FIG. 1 illustrates an ECM 132 within a power module 104 that includes one or more processors 134. The ECM 132 monitors and controls ground-fault detection circuit 110, including measurements sensed by first voltage monitor 510 and second voltage monitor 512 shown in FIG. 5, which are respectively arranged in parallel with first resistor 504 and second resistor 506. The ECM 132 may determine when a difference arises in the absolute value of voltage measured by first voltage monitor 510 and second voltage monitor 512 and when that difference exceeds a first predetermined threshold. As discussed above with respect to FIG. 5, a first predetermined threshold may be a level at which an abnormal condition exists and, for one example, may be 100 VDC, although the value will depend on the implementation, such as the values of R1 and R2 and the voltages conducted by positive rail 114 and negative rail 116.

Method 700 concludes with step 740, in which the one or more processors respond to the identification of the difference exceeding the first predetermined threshold. Specifically, the one or more processors cause an interruption of the electrical power delivery system. In one example discussed above for FIG. 5, after determining that a difference between the voltages measured by first voltage monitor 510 and second voltage monitor 512 exceed a threshold, such as 100 VDC, ECM 132 can respond to the difference to help protect against an electrical shock. The ECM 132 can activate first switch 514 and/or second switch 516 to interrupt the delivery of electrical power on rail system 102. The ECM could also sound an alarm or provide a notification to an operator or back office for electrical power delivery system 100.

Those of ordinary skill in the field will appreciate that the principles of this disclosure are not limited to the specific examples discussed or illustrated in the figures. For example, while the electrical power delivery system has been discussed in the context of power distribution over rails for a moving vehicle, other arrangements are feasible. The concepts are applicable to conductors that are not rails and not intended to deliver power to a moving vehicle and yet present a risk of electrical shock to humans or animals in contacting the conductors. Similarly, the system of conductors need not be elevated in a manner shown in FIGS. 2-4. The principles of the present disclosure apply equally to an arrangement of conductors placed closer to the ground and with object sensors arranged with their detection zones located to identify foreign objects above the conductors.

### Industrial Applicability

The present disclosure provides an electrical power delivery system for protecting against ground faults on power rails and otherwise guarding against electrical shock. An electrical power delivery system includes a power module and a rail system with a positive rail, a negative rail, and a ground rail. A resistor network, coupled to the rail system for ground-fault protection, provides a first resistance between the positive rail and the ground rail and a second resistance between the negative rail and the ground rail. An object sensor, coupled to the rail system, is configured to detect a foreign object within a sensing zone adjacent to the rail system. When making a detection, the object sensor affects one of the first resistance and the second resistance, which generates a simulated ground fault and causes the power module to activate an alarm or interrupt the rail system, helping protect the foreign object from electrical shock.

As noted above with respect to FIGS. 1-7, an electrical power delivery system such as 100 in FIGS. 1 and 5 may include a power module 104 with a power supply 112, ground-fault detection circuit 110, and ECM 132. In some examples, the power supply 112 generates a first voltage V1 of about +1500 VDC and a negative voltage V2 of about -1500 VDC. The ground-fault detection circuit 110 includes a balanced resistor network 502 between a first resistor 504 across the first voltage V1 and a second resistor 506 across the second voltage V2. A first voltage monitor 510 and a second voltage monitor 512 measure respective voltages across first resistor 504 and second resistor 506, and ECM 132 may activate one or both of a first switch 514 and a second switch 516 to disconnect either V1 or V2 if a difference between the measured voltages arises, which may be caused by a ground fault. One or more object sensors 152 along rail system 102 can detect a foreign object in the form of a person or animal proximate to power rails 108 and cause an imbalance in resistor network 502. This forced imbalance simulates a ground fault and enables ECM 132 to activate an alarm, interrupt rail system 102 with first switch 514 or second switch 516, or take other remedial action.

In the examples of the present disclosure, an electrical power delivery system 100 includes object sensors 152 for detecting humans or animals near high-power conductors that may lead to electrical shocks. The conductors may be power rails 108 exposed to the environment to enable connection with a current collector of a moving vehicle. Integrated with ground-fault detection, the system generates a simulated ground fault when a foreign object 314 is detected in a zone 302 near the rails by altering impedance between one of the energized rails and a ground rail. The sensors may be installed on structures elevating the rails, with their detection zones centered on regions adjacent to the rails where contact with the rails by a person or animal may be imminent.

The object sensors 152 and an associated simulated ground-fault circuit 520 may be configured such that multiple instances of the sensors along rail system 102 each provide communications to power module 104 in a way that ECM 132 can identify a location of the sensor. In some examples, sensors along rail system 102 may cause a different imbalance to resistor network 502, leading to a characteristic voltage difference as measured by first resistor 504 and second resistor 506. In other examples, sensors along rail system 102 may provide signals on ground rail 118 to power module 104 that vary over time in distinctive patterns. As well, the object sensors 152 may cause an impedance imbalance, and therefore a voltage imbalance between first voltage monitor 510 and second voltage monitor 512, that is substantially less than would arise from an actual ground fault, indicating to ECM 132 that the imbalance is a simulated ground fault caused by one or more of the object sensors 152. Accordingly, ECM 132 can delay interrupting rail system 102 for a short time while the person or animal moves away from power rails 108 in response to a warning or alarm.

Additionally, the implementation of object sensors 152 along power rails 108 to affect a balance of resistance between the rails avoids the need to provide separate wiring for powering the sensors and for communicating detection to power module 104 or to a back office. Instead, each device may be powered where installed and may communicate its detection and affect the balance of resistor network 502 from its installation along rail system 102. Therefore, the present disclosure further enables protection of personnel and animals in proximity to power rails with little material cost.

Unless explicitly excluded, the use of the singular to describe a component, structure, or operation does not exclude the use of plural such components, structures, or operations or their equivalents. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Terms of approximation are meant to include ranges of values that do not change the function or result of the disclosed structure or process. For instance, the term “about” generally refers to a range of numeric values that one of skill in the art would consider equivalent to the recited numeric value or having the same function or result. Similarly, the antecedent “substantially” means largely, but not wholly, the same form, manner or degree, and the particular element will have a range of configurations as a person of ordinary skill in the art would consider as having the same function or result.

While aspects of the present disclosure have been particularly shown and described with reference to the embodiments above, it will be understood by those skilled in the art that various additional embodiments may be contemplated by the modification of the disclosed systems and methods without departing from the spirit and scope of what is disclosed. Such embodiments should be understood to fall within the scope of the present disclosure as determined based upon the claims and any equivalents thereof.

What is claimed is:

1. An electrical power delivery system, comprising:
a power supply;
a rail system, comprising:
a positive rail coupled to receive positive voltage from the power supply,
a negative rail coupled to receive a negative voltage from the power supply, and
a ground rail coupled to the power supply and to ground; and
a protection circuit, comprising:
a resistor network coupled to the rail system, the resistor network configured to provide a first resistance between the positive rail and the ground rail and a second resistance between the negative rail and the ground rail; and
an object sensor, coupled to the rail system, configured to detect a foreign object within a sensing zone adjacent to the rail system, the object sensor being configured to change one of the first resistance and the second resistance in response to detecting the foreign object within the sensing zone.

2. The electrical power delivery system of claim 1, wherein the resistor network is part of a ground fault interrupter (GFI) circuit, the GFI being configured to interrupt the electrical power delivery system in response to an imbalance between the first resistance and the second resistance.

3. The electrical power delivery system of claim 2, further comprising:
a first voltage detector positioned to measure a first voltage across the first resistance; and
a second voltage detector positioned to measure a second voltage across the second resistance.

4. The electrical power delivery system of claim 3, further comprising an electronic control module (ECM) configured to cause interruption, after a delay, of the electrical power delivery system in response to a voltage difference between the first voltage and the second voltage exceeding a first predetermined threshold, the first predetermined threshold being indicative of the object sensor detecting the foreign object within the sensing zone.

5. The electrical power delivery system of claim 4, wherein the ECM is further configured to cause interruption of the electrical power delivery system in response to the voltage difference exceeding a second predetermined threshold indicative of a ground fault.

6. The electrical power delivery system of claim 2, wherein the GFI circuit detects a ground fault based on one of the first resistance and the second resistance being less than 50K Ohms.

7. The electrical power delivery system of claim 2, wherein the object sensor is configured, in response to detecting the foreign object within the zone, to change one of the first resistance and the second resistance to greater than 50K Ohms.

8. The electrical power delivery system of claim 2, wherein the object sensor is configured, in response to detecting the foreign object within the zone, to change one of the first resistance and the second resistance cyclically.

9. The electrical power delivery system of claim 2, wherein the object sensor is a first object sensor and the sensing zone is a first sensing zone, the electrical power delivery system further comprising a second object sensor configured to change one of the first resistance and the second resistance in response to detecting the foreign object within the second sensing zone.

10. The electrical power delivery system of claim 9, wherein the second object sensor changes one of the first resistance and the second resistance to an amount different from the first object sensor.

11. The electrical power delivery system of claim 10, wherein the second object sensor changes one of the first resistance and the second resistance at a rate over time different than the first object sensor.

12. The electrical power delivery system of claim 1, further comprising:
a support post elevating the rail system and the object sensor at least three meters above the ground, wherein a lower boundary of the sensing zone is at least one meter above the ground.

13. A protection circuit for an electrical power delivery system, comprising:
a resistor network configured to connect a positive conductor and a negative conductor to a ground conductor of the electrical power delivery system, the resistor network further configured to provide a first resistance between the positive conductor and the ground conductor and to provide a second resistance between the negative conductor and the ground conductor; and
an object sensor configured to detect a foreign object within a zone adjacent to the positive conductor and the negative conductor, the object sensor further configured to change one of the first resistance and the second resistance in response to detecting the foreign object within the zone.

14. The protection circuit of claim 13, wherein the object sensor changes one of the first resistance and the second resistance by adding an impedance between the ground conductor and one of the positive conductor and the negative conductor.

15. The protection circuit of claim 13, wherein the object sensor is configured, in response to detecting the foreign object within the zone, to change one of the first resistance and the second resistance cyclically.

16. The protection circuit of claim 13, wherein the object sensor is configured, in response to detecting the foreign object within the zone, to change one of the first resistance and the second resistance to greater than 50K Ohms.

17. A method, comprising:
detecting, with an object sensor, a foreign object within a zone adjacent to a positive rail, a negative rail, and a ground rail of an electrical power delivery system;
in response to detecting the foreign object within the zone, altering one of a first resistance between the positive rail and the ground rail and a second resistance between the negative rail and the ground rail;
identifying, by one or more processors, a difference between a positive voltage across the first resistance and a negative voltage across the second resistance exceeding a first predetermined threshold; and
in response to identifying the difference exceeding the first predetermined threshold, causing, by the one or more processors, an interruption of the electrical power delivery system.

18. The method of claim 17, further comprising:
after identifying the difference exceeding the first predetermined threshold, delaying for more than two seconds before causing the interruption of the electrical power delivery system.

19. The method of claim 17, further comprising:
decreasing one of the first resistance and the second resistance by an amount different from other object sensors in the electrical power delivery system.

20. The method of claim 17, further comprising:
in response to detecting the foreign object within the zone, cyclically increasing and decreasing one of the first resistance and the second resistance.
